(19) United States
(12) Patent Application Publication
(10) Pub. No.: US 2007/0153801 A1
(43) Pub. Date: Jul. 5, 2007

(54) Method and apparatus for scheduling to guarantee QoS of VoIP service in portable Internet system

(75) Inventors: Nak-Woon Sung, Daejeon-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/637,319

(22) Filed: Dec. 12, 2006

(30) Foreign Application Priority Data
Dec. 12, 2005 (KR) 10-2005-0121450

(51) Int. Cl. H04L 12/56; H04L 12/28

(52) U.S. Cl. 370/395.4; 370/395.21

(57) ABSTRACT

The present invention relates to a scheduling method and device for guaranteeing a voice over Internet protocol (VoIP) quality of service (QoS) in a portable Internet system. In the portable Internet system, when a packet for connecting a session between a base station and a portable Internet terminal is input for a VoIP service between a VoIP terminal and a portable Internet terminal, the session is connected by transmitting/receiving the packet through a management connection of a media access control (MAC) layer. In addition, an unsolicited grant service (UGS) connection is established between the base station and the portable Internet terminal after connecting the session between the base station and the portable Internet terminal. Then, the packet including data for the VoIP service is transmitted/received through the UGS connection to perform a voice call. Accordingly, a high quality VoIP service may be provided in a bad propagation environment.

### PRIORITY

This application claims priority under 35 U.S.C. §119 to a Korean application filed in the Korean Intellectual Property office on Dec. 12, 2005 and allocated Ser. No. 10-2005-0121450, the contents of which are incorporated herein by reference.

### BACKGROUND OF THE INVENTION

(a) Field of the Invention

The present invention relates to a portable Internet system. More particularly, the present invention relates to a scheduling method and device for guaranteeing a voice over IP (VoIP) quality of service (QoS) in a portable Internet system.

(b) Description of the Related Art Generally, since a portable Internet system (e.g., a wireless broadband internet (WiBro) system) uses a time division multiple access (TDMA) scheme, a terminal performs a radio resource allocation request process to perform uplink transmission.

In the WiBro system, two scheduling methods for providing a voice over IP (VoIP) quality of service (QoS) have been suggested.

In a first method, an unsolicited grant service (UGS) is used. In the method using the UGS, a terminal does not perform the radio resource allocation request process. Instead, a scheduler of a base station allocates a band for transmitting uplink data so as to satisfy values of delay and jitter that are agreed in a dynamic service addition (DSA) process.

In a second method, a real-time polling service (rtPS) is used. In the method using the rtPS, the scheduler of the base station receives radio resources from the terminal to periodically allocate a band for periodically requesting the radio resources. The terminal transmits data to the band allocated by the scheduler of the base station. Differing from the method using the UGS, in the method using the rtPS, overhead for firstly requesting a required band first is performed.

In the above method, a parameter defined in the DSA process is statically guaranteed regardless of the propagation environment (i.e., regardless of the current state of the terminal). A VoIP service is sensitive to delay and jitter, and has different propagation environments at a boundary area of a cell and at an area near the base station. Particularly, since the propagation environment differs when the terminal remains in a static state and when the terminal moves at a high speed, the VoIP QoS may not be guaranteed in the poor propagation environment when the same scheduling method is used.

In a conventional portable Internet system, a method for mapping the service to the UGS of the portable Internet is not defined when a VoIP application program in an upper layer starts a service. In addition, in the portable Internet system, an application service method is classified into four categories, and a scheduling operation is differently performed according to the categories. When a portable Internet terminal uses the conventional VoIP application program, corresponding data are regarded as normal data and are processed as a best effort service. In this case, it is defined in the portable Internet that the terminal requests the radio resource allocation from the base station, and there is a problem in that the allocated band does not guarantee the delay and jitter.

In the prior art, as a cell environment changes, performance is guaranteed by changing a codec of a coding rate or a modulation method of a modem, or performance is improved by changing characteristics of a physical layer (e.g., by using a hybrid automatic repeat request (H-ARQ)).

However, differing from data transmission requiring preciseness, since a VoIP service is further sensitive to the delay and jitter and a method for compensating a voice by using the previously received data is efficiently used, it is required to provide a method for guaranteeing performance in a layer that is higher than a physical layer (i.e., a medium access control (MAC) layer).

### SUMMARY OF THE INVENTION

The present invention has been made in an effort to provide a scheduling method and device for guaranteeing a voice over Internet protocol (VoIP) in a portable Internet system. In addition, the present invention has been made in an effort to provide a method and device for performing a scheduling operation according to the propagation environment of a terminal.

An exemplary scheduling device of a portable Internet system according to an embodiment of the present invention includes a packet access router accessed by a voice over Internet protocol (VoIP) system providing a VoIP service through an Internet network, and the scheduling device is accessed by a portable Internet terminal. The scheduling device includes a management processing unit, an unsolicited grant service (UGS) processing unit, a classifier, and a scheduler. The management processing unit transmits/receives a packet to/from the portable Internet terminal through a management connection. The UGS processing unit transmits/receives the packet to/from the portable Internet terminal through a UGS connection. The classifier classifies the packet transmitted/received to/from the portable Internet terminal, transmits the packet to the management processing unit when the packet is a control message for the VoIP service, and transmits the packet to the UGS processing unit when the packet is a data message for the VoIP service. The scheduler performs radio resource allocation to transmit/receive the packet.

An exemplary portable Internet terminal according to an embodiment of the present invention is accessed by a voice over Internet protocol (VoIP) user terminal accessed to a VoIP system providing a VoIP service through a base station of a portable Internet system. The portable Internet terminal includes a management processing unit, an unsolicited grant service (UGS), and a classifier. The management processing unit transmits/receives a packet to/from the base station through a management connection. The UGS processing unit transmits/receives the packet to/from the base station through a UGS connection. The classifier classifies the packet transmitted/received to/from the base station, transmits the packet to the management processing unit when the packet is a control message for the VoIP service, and transmits the packet to the UGS processing unit when the packet is a data message for the VoIP service.

In an exemplary scheduling method of a portable Internet system accessed to a voice over Internet protocol (VoIP) system providing a VoIP service through a base station, the scheduling method for transmitting/receiving a packet between a VoIP terminal accessed to the VoIP system and a portable Internet terminal, a session for the VoIP service between the VoIP terminal and the portable Internet terminal is connected by transmitting/receiving a packet through a management connection of a media access control (MAC) layer when the packet for connecting the session between a base station and the portable Internet terminal is input, an unsolicited grant service (UGS) connection between the base station and the portable Internet terminal is established after connecting the session between the base station and the portable Internet, and the packet is transmitted/received through the UGS connection and a voice call is performed when the packet including data for the VoIP service is input.

In an exemplary scheduling method of a portable Internet system accessed to a voice over Internet protocol (VoIP) system providing a VoIP service through a base station, the scheduling method for transmitting/receiving a packet between a VoIP terminal accessed to the VoIP system and a portable Internet terminal, the packet for connecting a session between the VoIP terminal and the portable Internet terminal is transmitted/received through a management connection of a media access control (MAC) layer and the packet including data for the VoIP service is transmitted/received through an unsolicited grant service (UGS) connection. In this case, in the scheduling method, a carrier-to-interference-and-noise ratio (CINR) measurement value is received from the portable Internet terminal, a CINR average value among the CINR measurement values is calculated, a CINR variance value is estimated based on the CINR measurement value and the CINR average value, a propagation environment variance direction of the portable Internet terminal is estimated based on the CINR average value and the CINR variance value, and a radio resource allocation method is established according to the estimated propagation environment variance direction.

Here, a packet that is greater than a first reference value is transmitted with a period that is greater than a second reference value when the CINR average value is greater than α and the CINR variance value is less than β, or when the CINR average value is greater than α and the CINR variance value is less than β (here, α and β are set values). In addition, a packet that is less than the first reference value is transmitted with a period that is less than the second reference value when the CINR average value is less than α and the CINR variance value is less than β, or when the CINR average value is greater than α and the CINR variance value is greater than β.

### BRIEF DESCRIPTION OF THE DRAWINGS

FIG. 1 shows a diagram of a frame configuration of a conventional orthogonal frequency division multiplexing (OFDM)/time division multiple access (TDMA) portable Internet system.

FIG. 2 shows a diagram representing an uplink data transmission process through a radio resource allocation process.

FIG. 3 shows a diagram of a configuration of a portable Internet system according to an exemplary embodiment of the present invention.

FIG. 4 shows a flowchart representing a VoIP service process in the portable Internet system according to the exemplary embodiment of the present invention.

FIG. 5 shows a flowchart representing a scheduling process according to variation of propagation environment in the portable Internet system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive. Like reference numerals designate like elements throughout the specification.

When it is described that an element is coupled to another element, the element may be directly coupled to the other element or coupled to the other element through a third element.

Hereinafter, an exemplary embodiment of the present invention will be described with reference to the figures.

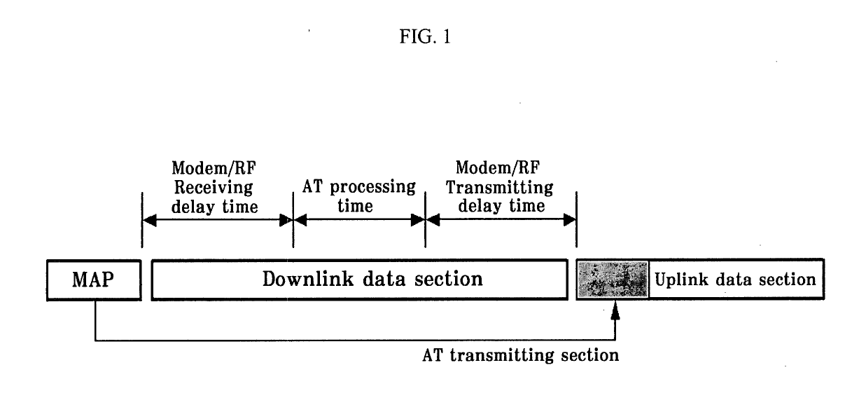

FIG. 1 shows a diagram of a frame configuration of a conventional orthogonal frequency division multiplexing (OFDM)/time division multiple access (TDMA) portable Internet system. A frame includes an uplink data section and a downlink data section.

An access point (AP) transmits data to an access terminal (AT) through the downlink data section. Each AT determines data corresponding to each AT through downlink map data transmitted to a preamble of each section, and receives the data.

The AT for transmitting the data to the AP determines, by uplink map data, whether a bandwidth allocated to the AT exists, and transmits a frame in an allocated section when there is the bandwidth allocated to the AT.

In this case, since web data have an asymmetrical characteristic, the downlink data section is set to be longer than the uplink data section. Generally, the AT in the TDMA system performs a radio resource request process for requesting the bandwidth from the AP when the data to be transmitted exists. In addition, the AT may transmit the data within a category granted by the AP.

In this portable Internet system, a voice over Internet protocol (VoIP) service has characteristics different from normal data services. Generally, in the data service, data are transmitted and received at a high speed without an error. However, in the VoIP service, a partial data loss may be accepted due to its service characteristics. Instead, a quality of service (QoS) of the VoIP service is determined by a delay and a jitter, and data quality that is deteriorated by the loss may be compensated by a sound quality compensating method.

In the portable Internet system, a scheduling method is categorized into four categories including an unsolicited grant service (UGS), a real-time polling service (rtPS), a non-real-time polling service (nrtPS), and a best effort (BE), so as to support the QoS of application services respectively having different characteristics. The scheduling method between the AT and the AP is established in an initial access setting process (i.e., a dynamic service addition (DSA) process).

Web traffic requiring asymmetrical and precise data transmission is supported by the BE method. In this case, the AT performs the radio resource allocation request (e.g., a random access) to transmit data.

A file transfer protocol (FTP) service is supported by the nrtPS method. In this case, differing from the BE method, the AP non-periodically provides an opportunity for receiving radio resources to the AT according to a parameter established in the DSA process.

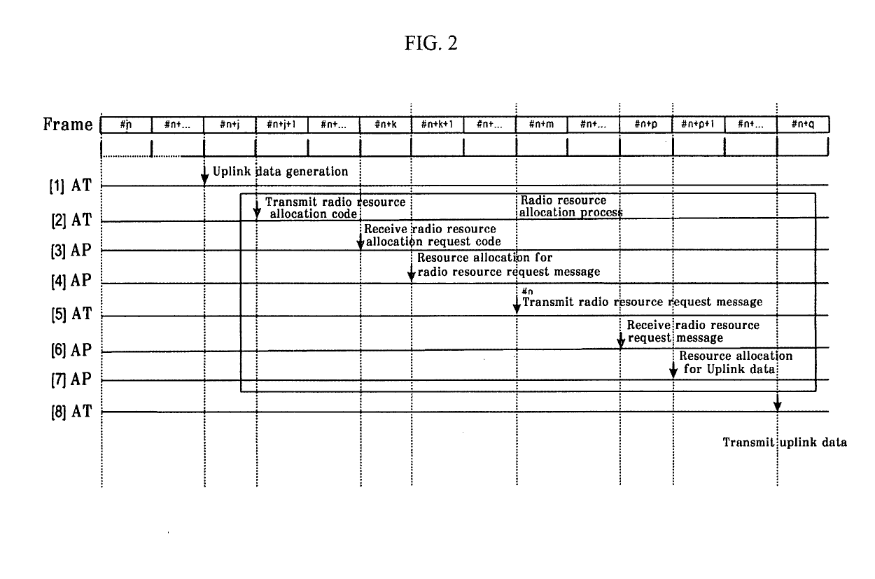

FIG. 2 shows a diagram representing the radio resource allocation process and an uplink data transmission process. As shown in FIG. 2, a considerable delay for the uplink data transmission is generated in the portable Internet system using the TDMA method. Accordingly, another scheduling method is required to guarantee quality of real-time services including a motion picture service, and the rtPS and UGS methods may be used for this purpose.

In the rtPS, a scheduler of the AP allocates a band for cyclically requesting a radio resource band to the AT. Accordingly, since required radio resources are requested through the allocated band, the AT transmits data to the AP through the radio resources allocated by the scheduler of the AP.

In the UGS method, differing from the rtPS method, an overhead for firstly requesting the band is not performed. That is, the AP scheduler provides an opportunity for cyclically transmitting the data to the AT without a request from the AT. Accordingly, to minimize the delay and the jitter, the VoIP service is required to be provided by the UGS method.

However, in the portable Internet system, it is not defined that the VoIP service is provided by the UGS method when terminal equipment (TES), such as a laptop computer, having a universal serial bus (USB) or a personal computer memory card international association (PCMCIA) interface performs a VoIP application program.

Accordingly, the scheduling method for supporting the VoIP service by the UGS method is provided in the exemplary embodiment of the present invention.

In the VoIP service, H.323 or session initiation protocol (SIP) is used for a call controlling operation. In this case, an H.323 AT uses H.245 protocol, H.225.0 protocol, and real-time transport protocol (RTP)/real-time transport control protocol (RTCP). In H.225, a reduced version of Q.931 is used to provide a connection setting function between two H323 end points. An H.245 control channel provides a capability exchange function, a mode setting function at a receiving terminal, a logical channel signal processing function, and a reliable in-band transmission function for control and display operations. In the RTP and the RTCP, after H.225 and H.245 connection setting and controlling processes are performed, an audio packet and a video packet are transmitted and received in real-time through a user datagram protocol/Internet protocol (UDP/IP) to perform an end-to-end voice call. In this case, an RTP header is requested to support stream-type audio and video. Since the RTP header includes a time stamp and a sequence number, a received device may generate sequential sound streams by synchronizing packets, and a buffering operation for packets required to eliminate the delay and the jitter may be performed.

A call setting and controlling function through a call signaling channel is a main function of the H.323 AT, and is performed by using necessary control signals of H.225.0 among various controls signals defined in Q.931. The H.323 protocol is transmitted according to audio, video, and other control signals and a transmission process of H.225.0, and a process for converting a data stream into a message to be transmitted to a network, a process for converting the message into the data stream, a logical framing process, a sequence number supplying process, and an error detection and correction process are performed by the H.225.0 protocol, the Q.931 protocol, a registration, admission, and status (RAS) protocol, and the RTP/RTCP protocol.

The H.245 control channel is used to transmit control messages for managing operations of H.323 constituent elements, and a capability exchange message, a capability negotiation, an open/close message of a logical channel used to transmit the audio and video data, a flow controlling message, a normal command message, and a confirm message are transmitted through the H.245 control channel. One H.245 control channel exists for each call.

Accordingly, when the TES including the laptop computer performs the VoIP application program by using the H.323 protocol to dial numbers by a user, a CALL SETUP message that is an H.225.0 protocol message is generated. The CALL SETUP message that is a payload of a transmission control protocol (TCP)/Internet protocol (IP) packet is transmitted between each end point.

A configuration of the portable Internet system supporting the VoIP service according to the exemplary embodiment of the present invention will now be described.

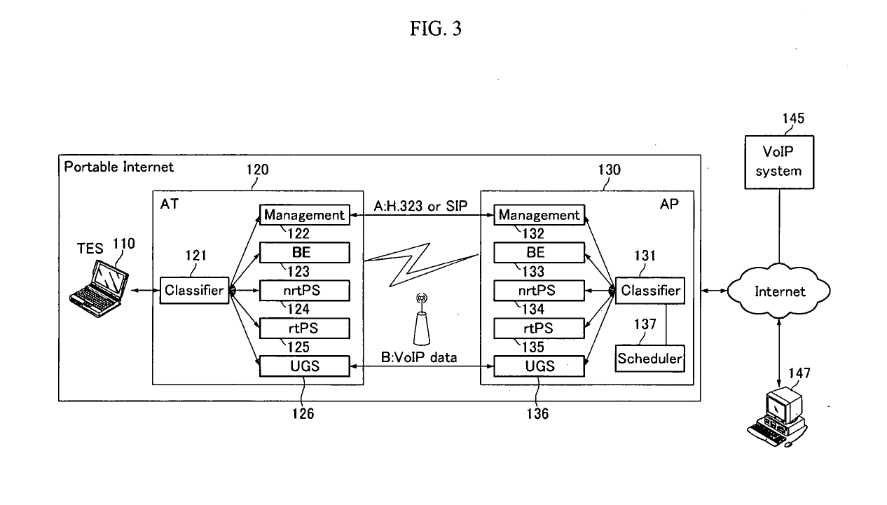

FIG. 3 shows a diagram of the configuration of the portable Internet system according to the exemplary embodiment of the present invention, and it particularly shows the configuration of the portable Internet system applying the UGS method to the VoIP service.

As shown in FIG. 3, the portable Internet system according to the exemplary embodiment of the present invention includes terminal equipment (TES) 110, an access point (AP) 130 connected to an access terminal (AT) 120, and a packet access router (PAR) accessed to the AP 130. A VoIP system 145 and a VoIP user terminal 147 are connected to the packet access router 140 through the Internet. Here, the VoIP user terminal 147 may be simply referred to as a VoIP terminal, and the AT 120 may be referred to as a “terminal”.

The VoIP system 145 may use the H.323 or SIP. When using the SIP protocol to provide VoIP service, the VoIP system includes an SIP proxy server and an SIP redirect server. In this case, the VoIP user terminal 147 and the TES 110 are accessed to the VoIP system 145 and the Internet, and include the VoIP application program using the SIP protocol.

When the VoIP service using the H.323 protocol is provided, the VoIP system 145 includes an H.323 gateway and an H.323 gate keeper. In this case, the VoIP user terminal 147 is accessed to the VoIP system 145 and the Internet network, and uses the H.323 terminal including the VoIP application program using the H.323 protocol.

The TES 110 is accessed to the AT 120 and the USB or the PCMCIA interface, and it includes the VoIP application program by the H.323 protocol or the SIP protocol. The AT 120 includes an AT classifier 121 for establishing wireless access to the AP 130, classifying received traffic, and commanding a new access establishment.

The AP 130 is accessed to the Internet network through the PAR 140, and is accessed to the AT 120 by allocating radio resources. The AP 130 includes an AP classifier 131 for classifying inflow traffic and commanding a new access establishment, and a scheduler 137 for allocating the radio resources to provide an opportunity for transmitting/receiving data for each AT 120.

When the AT 120 receives a new TCP packet such as an H.225 message, the AT classifier 121 performs a dynamic service addition (DSA) process for establishing a traffic flow between the AT 120 and the AP 130, considers a received service as a web service in general (i.e., when there is no specific command), and maps the scheduling method as the BE method. In this case, there is a problem in that a VoIP call process message or VoIP data according to the H.225 protocol may be mapped to be scheduled in the BE method, which is solved by the following method according to the exemplary embodiment of the present invention.

When the AT classifier 121 receives the H.225 message and maps it as the UGS, parameters including the jitter and the delay for the UGS service access flow may not be defined, since another TCP connection is established after an initial connection is established by the H.225, and VoIP characteristics are defined by an H.245 terminal capability message in the H.323 protocol. In the H.323 protocol, when a H.323 call control message and data are mapped to one connection flow, a large number of operations for managing a VoIP call are required. That is, the AT classifier 121 and the AP classifier 131 are required to inspect packets transmitted to the corresponding connection flow.

Accordingly, in the exemplary embodiment of the present invention, the H.225.0 message and the H.245 message are mapped to a management service so as to separate them into a control message and a data message.

For this purpose, the AP 130 and the AT 120 include management processing units 132 and 122 for transmitting/receiving a packet based on the management service, BE processing units 133 and 132 for transmitting/receiving the packet based on the BE service, nrtPS processing units 134 and 124 for transmitting/receiving the packet based on the nrtPS service, rtPS processing units 135 and 125 for transmitting/receiving the packet based on the rtPS service, and the UGS processing unit 136 and 126 for transmitting/receiving the packet based on the UGS service. A scheduling device may include the AP classifier 131, the management processing unit 132, the BE processing unit 133, the nrtPS processing unit 134, the rtPS processing unit 135, the UGS processing unit 136, and the scheduler 137 of the AP 130.

The AT classifier 121 and the AP classifier 131 according to the exemplary embodiment of the present invention perform the following functions.

[S1] The classifiers 121 and 131 classify an H.225.0 CALL SETUP packet having a destination port number of a set value (e.g., 1720) among the inflow TCP packets as the management message, and transmit the corresponding packet to the management processing units 132 and 122.

[S2] The classifiers 121 and 131 classify an H.225.0 CALL ALERTING/CONNECT packet having a source port number of the set value (e.g., 1720) among the inflow TCP packets as the management message, and transmit the corresponding packet to the management processing units 132 and 122. In this case, the classifiers 121 and 131 store TCP port information and an IP address for an H.245 session of an opposite side node among components of the CALL ALERTING/CONNECT message.

[S3] The classifiers 121 and 131 classify a terminal capability packet having the destination or source port number that is the same as the TCP port number for the H.245 session stored in step S2 among the inflow TCP packets as the management message, and transmit the corresponding packet to the management processing units 132 and 122. In this case, the classifiers 121 and 131 store call parameters of codecs including audio codecs (G.711, G.722, G.723.1, and G.729) and video codecs (H.261, H.263, and H.264) among components of the terminal capability message.

[S4] The classifiers 121 and 131 classify an open logical channel packet having a destination or source port number that is the same as the TCP number for the H.245 session stored in step S2 among the inflow TCP packets as the management message, and transmit the corresponding packet to the management processing units 132 and 122. In this case, the classifiers 121 and 131 respectively store UDP port information of the RTCP protocol among components of the open logical channel message.

[S5] The classifiers 121 and 131 classify an open logical channel acknowledgment message having the destination or source port number that is the same as the TCP number for the H.245 session stored in step S2 among the inflow TCP packets as the management message, and transmit the corresponding packet to the management processing units 132 and 122. In this case, the classifiers 121 and 131 store the UDP port information of the RTP protocol used to transmit actual voice traffic among components of the open logical channel acknowledge message. In addition, the DSA process for establishing the UGS connection flow between the AT 120 and the AP 130 is performed. In this case, a connection flow parameter refers to the call parameter stored in step S3.

[S6] The classifiers 121 and 131 establish the UGS connection between the classifiers 131 and 121 of the other node.

[S7] The classifiers 121 and 131 transmit a packet having the destination or source port number that is the same as the UDP port stored in step S5, through the UGS connection flow established in step S4. That is, the packet is transmitted to the UGS processing units 136 and 126, and is transmitted/received through the UGS connection flow formed between the UGS processing units 136 and 126.

[S8] The classifiers 121 and 131 classify a close logical channel packet that is the same as the stored H.245 session port number among the inflow TCP packets as the management message, and transmit the corresponding packet to the management processing units 132 and 122. In this case, classifiers 121 and 131 perform a dynamic service deletion (DSD) process for the currently established UGS connection flow.

[S9] The classifiers 121 and 131 release the UGS connection formed between the classifiers 131 and 121 of the other node.

[S10] The classifiers 121 and 131 classify an H.225.0 RELEASE packet as the management message among the inflow TCP packets, and transmit the corresponding packet to the management processing units 132 and 122. In this case, the AT classifier 121 and the AP classifier 131 reset current VoIP-related parameters.

An operation of the portable Internet system according to the exemplary embodiment of the present invention will now be described.

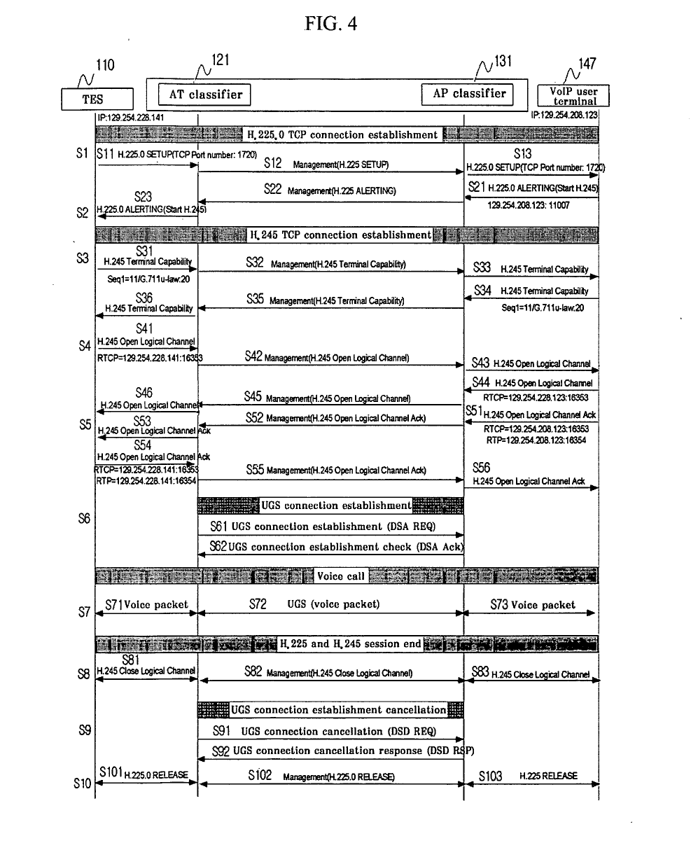

FIG. 4 shows a flowchart representing a VoIP service process in the portable Internet system according to the exemplary embodiment of the present invention. In FIG. 4, an H.323-based VoIP service for guaranteeing the VoIP QoS in the portable Internet system is exemplified, and it is assumed that the TES 110 performs a voice call with the VoIP user terminal 147 through the VoIP system 145 using the H.323 protocol connected to a wired Internet. Here, the TES 110 uses an Internet address of 129.254.228.141, and the VoIP user terminal 147 uses an IP address of 129.254.208.123.

When a user inputs a phone number to the TES 110, the TES 110 transmits an H.225.0 SETUP TCP packet to the AT 120 in step S11. In this case, since the destination port number of the TCP packet is the set value (e.g., 1720), the AT classifier 121 does not perform a BE connection establishment process for the H.225.0 SETUP TCP packet, but transmits the H.225.0 SETUP TCP packet to the AP 130 through the management connection in step S12. That is, the packet is transmitted to the VoIP user terminal 147 through the management processing unit 132 of the AP 30 by transmitting the packet to the management processing unit 122 in step S13.

The VoIP user terminal 147 receiving the H.225.0 SETUP TCP packet transmits an H.225 ALERTING TCP packet having a TCP port number 11007 for its own H.245 session to the AP 130 to start the H.245 session in step S21. In this case, the source port number of the H.225 ALERTING TCP packet is 1720.

Since the source port number of the received H.225 ALERTING TCP packet is 1720, the classifier 131 of the AP 130 stores the TCP port number 11007 for the H.245 session and transmits the corresponding packet to the management processing unit 132. Accordingly, the H.225 ALERTING TCP packet is transmitted to the AT 120 through the management connection in step S22.

The classifier 121 of the AT 120 stores the TCP port number for the H.245 session from the transmitted H.225 ALERTING TCP packet, and transmits the corresponding packet to the TES 110 in step S23. The TES 110 uses the TCP port number (e.g., 11007) transmitted through the H.225 ALERTING TCP packet to establish an H.245 TCP connection, and transmits the H.245 Terminal Capability message to the AT 120 through the H.245 TCP connection in step S31.

When the destination port number of the H.245 Terminal Capability TCP packet is the same as the preciously stored H.245 session port number (e.g., 11007), the AT classifier 121 stores voice call parameter information related to the voice codec, and transmits the H.245 Terminal Capability message to the AP 130 through the management processing unit 122 in step S32.

The AP classifier 131 stores the voice call parameter information of the H.245 Terminal Capability packet, and transmits the corresponding packet to the VoIP user terminal 147 in step S33. In addition, the VoIP user terminal 147 generates its own H.245 Terminal Capability message to transmit it to the AP 130 in step S34. The AP classifier 131 stores the H.245 Terminal Capability message, and transmits the message to the AT 120 through the management processing unit 132 in step S35. The AT 120 stores the H.245 Terminal Capability message, and transmits the message to the TES 110 in step S36.

When a call capability negotiation is finished, the TES 110 transmits the H.245 Open Logical Channel message to the AT 120 to open a channel for transmitting traffic in step S41. The H.245 Open Logical Channel message includes an address (129.254.228.141) and a port number (16353) of its own RTCP/UDP protocol for controlling the RTP protocol.

The AT classifier 121 stores the address and port information (129.254.228.141 and 16353) of the RTCP/UDP protocol as UGS downlink connection information from the H.245 Open Logical Channel message having the transmitted TCP packet destination port number that is the same as the stored H.245 session port number 11007, and transmits the H.245 Open Logical Channel message to the AP 130 through the management processing unit 122 in step S42.

The AP classifier 131 stores the H.245 Open Logical Channel message as uplink connection information, and transmits the message to the VoIP user terminal 147 in step S43. The VoIP user terminal 147 transmits the H.245 Open Logical Channel message to the TES 110 through the AP classifier 131 and the AT classifier 121 to open the traffic channel in steps S44, S45, and S46. In a like manner, the AT classifier 121 and the AP classifier 131 detect the address and port information (129.254.208.123 and 16353) of the RTCP/UDP protocol from the H.245 Open Logical Channel message, and store the information as UGS uplink connection information.

The VoIP user terminal 147 generates an acknowledgement message in response to the H.245 Open Logical Channel message, and transmits an H.245 Open Logical Channel Ack message to the TES 110 through the AP classifier 131 and the AT classifier 121 in steps S51, S52, and S53. In this case, the AT classifier 121 and the AP classifier 131 store the address and port information (129.254.208.123 and 16354) of the UGS uplink RTP/UDP protocol and the address and port information (129.254.228.141 and 16354) of the UGS downlink RTP/UDP protocol for transmitting the voice traffic.

The TES 110 generates an acknowledgement in response to the H.245 Open Logical Channel message, and transmits the H.245 Open Logical Channel Ack message to the VoIP user terminal 147 through the AT classifier 121 and the AP classifier 131 in steps S54, S55, and S56. In this case, the AT classifier 121 and the AP classifier 131 include the address and port information (129.254.208.123 and 16354) of the UGS uplink RTP/UDP protocol, and the address and port information (129.254.228.141 and 16354) of the UGS downlink RTP/UDP protocol for transmitting the voice traffic.

After transmitting the H.245 Open Logical Channel Ack message, the AT classifier 121 establishes the UGS connection between the AT 120 and the AP 130 for transmitting the voice traffic. The AT classifier 121 transmits a dynamic service addition request (DSA-REQ) message that is a connection flow establishment message to the AP classifier 131 through the UGS processing unit 126 in step S61 to establish the UGS connection.

The AP classifier 131 transmits a DSA-ACK message in response to the DSA-REQ message to the AT classifier 121 to establish the UGS connection in step S62. In this case, the AT 120 refers the previously stored H.245 Terminal Capability message information to establish a UGS connection parameter.

Subsequently, the AT classifier 121 transmits the UDP packets having the destination address and the port number of 129.254.208.123:16353, 16354 among the UDP packets transmitted from the TES 110 through the established UGS connection. In a like manner, the AP classifier 130 transmits the packets having the destination and port number of 129.254.228.141:16353, 16354 among the received UDP packet through the UGS connection. Accordingly, the AT UGS processing unit 126 and the AP UGS processing unit transmit/receive the packet having the destination address and port number of 129.254.228.141:16353, 16354. After establishing the UGS connection, the TES 110 and the VoIP user terminal 147 transmits/receives a voice packet through the AT classifier 121 and the AP classifier 131 to perform the voice call in steps S71, S72, and S73.

To finish the voice call after performing the voice call, the TES 110 generates an H.245 Close Logical Channel message, and transmits it to the VoIP user terminal 147 through the AT classifier 121 and the AP classifier 131 in steps S81, S82, and S83. In this case, the AT classifier 121 transmits the TCP packet for the H.245 Close Logical Channel message to the AP 130 through the management processing unit 122, and requests to release the UGS connection.

To release the UGS connection, the AT classifier 121 transmits a dynamic service deletion request (DSD-REQ) message to the AP classifier 131 in step S91. The AP classifier 131 transmits a dynamic service deletion response (DSD-RSP) message to the AT classifier 121 and releases the UGS connection in step S92.

Finally, the TES 110 transmits an H.225.0 Release message to the VoIP user terminal 147 through the AT 120 and the AP 130 to release all the connections in steps SS101, S102, and S103. In this case, the AT 120 and the AP 130 transmit the H.225.0 Release message by the classifiers 121 and 131 through the management connection, and reset the stored VoIP parameters when receiving the TCP packet.

Protocol and port numbers of the respective messages in the exemplary embodiment of the present invention are only examples, and they are not limited thereto.

In addition, an opportunity for cyclically transmitting the VoIP for the UGS connection flow is provided to the AT in the portable Internet system. Since the portable Internet system is the TDMA system, the AT transmits a message or data for the VoIP based on a radio resource allocation method of the AP scheduler 137. Accordingly, performance of the AT used in the TES 110 is determined by the scheduling method of the AP scheduler 137. The simplest scheduling method is to transmit a fixed size packet during a fixed period so as to satisfy a call establishment parameter established when the UGS connection flow is established.

In addition, the propagation environment of the AT varies according to various conditions. That is, according to whether the AT is close to an AP antenna having an appropriate propagation environment within a cell radius of the AP, whether the AT is positioned at a cell edge having a deteriorated propagation environment, or whether the AT is positioned dynamically or statically, the propagation environment may vary. In the various conditions, the high quality VoIP service may not be guaranteed by a static scheduling method for satisfying the parameter when establishing the UGS connection flow. Accordingly, in the exemplary embodiment of the present invention, a method for detecting the various propagation environments by the AT, and an appropriate scheduling method for the propagation environments of each AT, will be described.

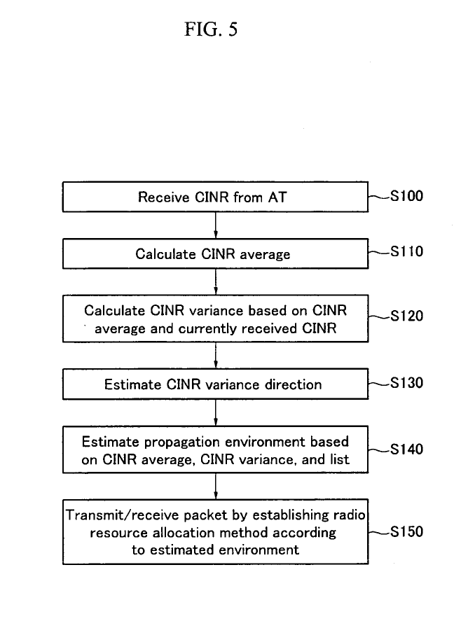

FIG. 5 shows a flowchart representing a scheduling process according to variation of the propagation environment in the portable Internet system according to the exemplary embodiment of the present invention.

In the exemplary embodiment of the present invention, a carrier-to-interference-and-noise ratio (CINR) is used to estimate the propagation environment of the AT. Generally, since it is defined in the portable Internet system that the AT is required to cyclically inform the AP of the CINR, an exponential moving average for the CINR is used to estimate the variation of the propagation environment during a predetermined period. For this purpose, the CINR transmitted from the AT is received in step S100, and a CINR average value is estimated in step S110. A weight value that is lower than a reference value is applied to a newest value, a weight value that is higher than the reference value is an old value, and therefore an error that may be caused by an unexpected variation of the propagation environment is minimized. The above method is more sensitive to trends compared to a simple moving average. A method for calculating the SINR average value according to the exemplary embodiment of the present invention will now be described.
CINR_{average}=w*CINRᵢ+1−w*CINCRᵢ₋₁ [Equation 1]

Here, when 0<w<1 and CINR_{average}>α, the propagation environment is good.

In Equation 1, a weight w of a current CINRᵢ for a previous CINRᵢ₊₁ is set to be lower than a predetermined value (e.g., 0.3), the propagation environment of the current AT is applied, and an error of an irregular propagation estimate value may be minimized. For this purpose, in the exemplary embodiment of the present invention, the AT 120 cyclically informs the AP scheduler 137 of the current CINRᵢ, and the AP scheduler 137 maintains a CINR_{average} value according to Equation 1.

In addition, the AP scheduler 137 estimates a CINR variance value CINR_{variance} in step S120 by using the current CINRᵢ and the CINR_{average} transmitted from the AT 120 so as to estimate the variation of the propagation environment of the AT 120.
CINR_{variance}=(CINRᵢ−CINR_{average})² [Equation 2]

Here, when CINR_{variance}>β, it is assumed that the variance is greater than the reference value.

The AP scheduler 137 measures and maintains a CINR_{variance direction} list (i.e., a list of the CINR_{variance direction} (CINRᵢ−CINR_{average}) for a predetermined time in step S130 to estimate a propagation environment variation direction of the AT 120.

In the exemplary embodiment of the present invention, the calculated variable is used to estimate the propagation environment of the current AT 120 as the four following propagation environment categories according to a corresponding condition in step S140.
{CINR_{average}>α and CINR_{variance}<β} [B1]

In the CINR transmitted from the AT 120, the propagation environment of the AT 120 is good since CINR_{average}>α, and the propagation environment of the current AT 120 is the same as the previous propagation environment since CINR_{variance}<β. That is, the propagation environment of the AT 120 slowly varies or is maintained at a static state. In this case, the propagation environment of the AT 120 gradually varies to be good when the value of CINR_{variance direction} list includes more positive numbers, and they gradually vary to be bad when the value includes more negative numbers.
{CINR_{average}<α and CINR_{variance}<β} [B2]

In the CINR transmitted from the AT 120, the propagation environment of the AT 120 is not good since CINR_{average}<α, and the propagation environment of the current AT 120 is the same as the previous propagation environment since CINR_{variance}<β. That is, the AT 120 is positioned in the bad propagation environment. In this case, the propagation environment of the AT 120 gradually varies to be good when the value of CINR_{variance direction} list includes more positive numbers, and the propagation environment of the AT 120 varies to be bad when the value includes more negative numbers.
{CINR_{average}>α and CINR_{variance}>β} [B3]

In the CINR transmitted from the AT 120, the propagation environment of the AT 120 is good since CINR_{average}>α, and the propagation environment of the current AT 120 rapidly varies since CINR_{variance}>β. In this case, the propagation environment of the AT 120 rapidly varies to be good when the value of CINR_{variance direction} list includes more positive numbers, and the propagation environment of the AT 120 rapidly varies to be bad when the value includes more negative numbers.
{CINR_{average}<α and CINR_{variance}>β} [B4]

In the CINR transmitted from the AT 120, the propagation environment of the AT 120 is not good since CINR_{average}<α, and the propagation environment of the current AT 120 rapidly varies since CINR_{variance}>β. In this case, the propagation environment of the AT 120 rapidly varies to be good when the value of CINR_{variance direction} list includes more positive numbers, and the propagation environment of the AT 120 rapidly varies to be bad when the value includes more negative numbers.

In the exemplary embodiment of the present invention, the AP scheduler 137 establishes the radio resource allocation method as in the following algorithms according to the estimated categories, and transmits the VoIP data through the UGS connection in step S150. Here, the following algorithms are applied to the VoIP transmitted through the UGS connection in the exemplary embodiment of the present invention, but it is not limited thereto.

[C1] {When the AT is in the Condition B1}

The AT 120 is positioned in a good propagation environment, so the propagation environment gradually varies or remains at a static state, and therefore a packet that is comparatively greater than a first reference value is transmitted during a period that is greater than a second reference value so that a processing time of the AT 120 may be reduced within a range satisfying the VoIP delay.

[C2] {When the AT is Positioned in the Condition B2}

The AT 120 is positioned in the bad propagation environment, so the propagation environment gradually varies or remain in the static state, and therefore a packet that is comparatively lesser than the first reference value is transmitted during a period that is less than the second reference value so that the number of successively received packets is increased and a compensating method for the loss packets at a receiving terminal may be applied.

[C3] {When the AT is Positioned in the Condition B3}

The AT 120 is positioned in the good propagation environment, and the probability that the AT 120 is on the move is high (i.e., the propagation environment rapidly varies). Accordingly, when the AT 120 moves to the bad propagation environment from the good propagation environment, the packet that is lesser than the first reference value is transmitted during the period less than the second reference value, and therefore a packet loss caused by a sudden deterioration of the propagation environment may be minimized.

[C4] {When the AT is Positioned in the Condition B4}

The AT 120 is positioned in the bad propagation environment, and the probability that the At 120 is on the move is high. Accordingly, when the AT 120 moves from the good propagation environment to the bad propagation environment, since transmission failure probability is high compared to the number of transmissions, the packet that is greater than the first reference value is transmitted during the period that is greater than the second reference value, and the transmission failure probability is reduced.

As described, in the exemplary embodiment of the present invention, the AP uses the CINR average, the variance, and the variance list to determine the propagation environment of the AT. Since the packet that is lesser than the first reference value is frequently transmitted when the propagation environment rapidly varies in the propagation environment that is better than the reference value and the AT moves from the propagation environment that is worse than the reference value to the propagation environment that is better than the reference value, the packet loss caused by the sudden deterioration of the propagation environment is minimized.

However, since the packet that is greater than the first reference value is occasionally transmitted because the transmission failure probability is higher than the number of transmissions when the propagation environment is generally worse than the reference value and rapidly varies, and the AT moves from the propagation environment that is better than the reference value to the propagation environment that is worse than the reference value, the transmission failure probability may be reduced.

In addition, when the propagation environment gradually varies or remains at the static state in the propagation environment that is better than the reference value, the large packet is occasionally transmitted to reduce the processing time.

Accordingly, when the propagation environment gradually varies or remains at the static state in the generally worse propagation environment, the packet that is lesser than the first reference value is frequently transmitted, and therefore a voice compensating effect may be achieved.

Accordingly, in the exemplary embodiment of the present invention, real-time service is guaranteed since the VoIP service is mapped to the IGS flow of the portable Internet system, the AP scheduling method varies according to the propagation environment of the AT, and therefore a good VoIP quality may be provided when the propagation environment is bad.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the exemplary embodiment of the present invention, the call establishment process of the VoIP application program of an application layer in the portable Internet system is transmitted through the management connection of the portable Internet MAC layer, the voice traffic is mapped to the UGS service of the portable Internet MAC layer, and therefore the VoIP data may be transmitted in real-time and the QoS may be guaranteed.

In addition, since the current state of the AT is informed to the AP by using the CINR_{average}, the variance, and the variance list when the UGS connection is established, the AP scheduler provides an appropriate scheduling method for the variation of the propagation environment of the AT rather than the static scheduling method, and therefore the VoIP voice quality may be increased.

What is claimed is:

1. A scheduling device of a portable Internet system, the scheduling device comprising a packet access router accessed to a voice over Internet protocol (VoIP) system providing a VoIP service through an Internet network, the scheduling device accessed to a portable Internet terminal, the scheduling device comprising:
a management processing unit for transmitting/receiving a packet to/from the portable Internet terminal through a management connection;
an unsolicited grant service (UGS) processing unit for transmitting/receiving the packet to/from the portable Internet terminal through a UGS connection;
a classifier for classifying the packet transmitted/received to/from the portable Internet terminal, transmitting the packet to the management processing unit when the packet is a control message for the VoIP service, and transmitting the packet to the UGS processing unit when the packet is a data message for the VoIP service; and
a scheduler for performing radio resource allocation to transmit/receive the packet.

2. The scheduling device of claim 1, wherein the scheduler measures a propagation environment of the portable Internet terminal based on a signal transmitted from the portable Internet terminal, and performs the radio resource allocation according to a measurement result.

3. The scheduling device of claim 2, wherein the signal transmitted from the portable Internet terminal is a carrier-to-interference-and-noise ratio (CINR) measurement value.

4. The scheduling device of claim 3, wherein the scheduler calculates a CINR average value of the CINR measurement values transmitted from the portable Internet terminal, estimates a CINR variance based on the CINR measurement value and the CINR average value, and estimates a propagation environment variance direction of the portable Internet terminal.

5. The scheduling device of claim 4, wherein CINR variance direction values indicating a difference between the CINR measurement value and the CINR average value are obtained, it is determined that a propagation environment of the terminal becomes good when the number of positive numbers among the CINR variance direction values is larger than the number of negative numbers, and it is determined that the propagation environment of the terminal becomes bad when the number of negative numbers is larger than the number of positive numbers.

6. The scheduling device of claim 4, wherein the scheduler controls the UGS processing unit to transmit a packet that is greater than a first reference value with a period that is greater than a second reference value when the CINR average value is greater than α and the CINR variance value is less than β, or when the CINR average value is greater than α and the CINR variance value is less than β (here, α and β are set values).

7. The scheduling device of claim 4, wherein the scheduler controls the UGS processing unit to transmit a packet that is lesser than a first reference value with a period that is less than a second reference value when the CINR average value is less than α and the CINR variance value is less than β, or when the CINR average value is greater than α and the CINR variance value is greater than β (here, α and β are set values).

8. The scheduling device of claim 1, further comprising at lease one among:
a real-time polling service (rtPS) processing unit for transmitting/receiving a packet to/from the portable Internet terminal based on an rtPS;
a non-real-time polling service (nrtPS) processing unit for transmitting/receiving the packet to/from the portable Internet terminal based on an nrtPS; and
a best effort (BE) processing unit for transmitting/receiving the packet to/from the portable Internet terminal based on a BE service.

9. A portable Internet terminal accessed to a voice over Internet protocol (VoIP) user terminal accessed to a VoIP system providing a VoIP service through a base station of a portable Internet system, the portable Internet terminal comprising:
a management processing unit for transmitting/receiving a packet to/from the base station through a management connection;
an unsolicited grant service (UGS) processing unit for transmitting/receiving the packet to/from the base station through a UGS connection; and
a classifier for classifying the packet transmitted/received to/from the base station, transmitting the packet to the management processing unit when the packet is a control message for the VoIP service, and transmitting the packet to the UGS processing unit when the packet is a data message for the VoIP service.

10. The portable Internet terminal of claim 9, wherein terminal equipment including a VoIP application program is accessed to the portable Internet terminal through a predetermined communication interface.

11. The portable Internet terminal of claim 9, further comprising at least one among:
a real-time polling service (rtPS) processing unit for transmitting/receiving a packet to/from the base station based on an rtPS;
a non-real-time polling service (nrtPS) processing unit for transmitting/receiving the packet to/from the base station based on an nrtPS; and
a best effort (BE) processing unit for transmitting/receiving the packet to/from the base station based on a BE service.

12. A scheduling method of a portable Internet system accessed to a voice over Internet protocol (VoIP) system providing a VoIP service through a base station, the scheduling method for transmitting/receiving a packet between a VoIP terminal accessed to the VoIP system and a portable Internet terminal, the scheduling method comprising:
when a packet for connecting the session between a base station and the portable Internet terminal is input, connecting a session for the VoIP service between the VoIP terminal and the portable Internet terminal by transmitting/receiving the packet through a management connection of a media access control (MAC) layer;
establishing a unsolicited grant service (UGS) connection between the base station and the portable Internet terminal after connecting the session between the base station and the portable Internet; and
when the packet including data for the VoIP service is input, transmitting/receiving the packet through the UGS connection, and performing a voice call.

13. The scheduling method of claim 12, further comprising, after the VoIP service is finished between the VoIP terminal and the portable Internet terminal, transmitting/receiving a predetermined packet through the management connection of the MAC layer and canceling the IGS connection.

14. The scheduling method of claim 12, wherein the connecting of the session comprises:
establishing a transport control protocol (TCP) connection by receiving a setup message transmitted from the base station and the portable Internet terminal through the management connection, transmitting the setup message to the VoIP terminal, and transmitting an alerting message from the VoIP terminal to the portable Internet terminal; and
receiving a call capacity negotiation between the portable Internet terminal and the VoIP terminal by receiving a message including voice call parameter information from the portable Internet terminal through the management connection and transmitting the voice call parameter information to the VoIP terminal.

15. The scheduling method of claim 14, further comprising resetting the voice call parameter information when the input packet includes a release message.

16. The scheduling method of claim 12, wherein, in the establishing of the UGS connection, a message including UGS downlink connection information including protocol address and port information is received from the portable Internet terminal through the management connection, the UGS downlink connection information is stored, and the UGS downlink connection information is transmitted to the VoIP terminal, so as to establish the UGS connection.

17. The scheduling method of claim 16, wherein, in the performing of the voice call, the packet is transmitted/received through the UGS connection when a port number of the input packet is the same as the port number included in the connection information.

18. The scheduling method of claim 12, further comprising measuring a propagation environment of the portable Internet terminal based on a signal transmitted from the portable Internet terminal, and establishing a method for performing radio resource allocation according to a measurement result.

19. The scheduling method of claim 18, wherein the establishing of the method comprises:
receiving a carrier-to-interference-and-noise ratio (CINR) measurement value from the portable Internet terminal;
calculating a CINR average value among the CINR measurement values;
estimating a CINR variance value based on the CINR measurement value and the CINR average value;
estimating a propagation environment variance direction of the portable Internet terminal based on the CINR average value and the CINR variance value; and
establishing a radio resource allocation method for transmitting/receiving the packet according to the estimated propagation environment variance direction.

20. The scheduling method of claim 19, further comprising:
establishing the radio resource allocation method that transmits the packet that is greater than a first reference value with a period that is greater than a second reference value when the CINR average value is greater than α and the CINR variance value is less than β, or when the CINR average value is greater than α and the CINR variance value is less than β (here, α and β are set values); and
establishing the radio resource allocation method that transmits the packet that is lesser than the first reference value with a period that is less than the second reference value when the CINR average value is less than α and the CINR variance value is less than β, or when the CINR average value is greater than α and the CINR variance value is greater than β (here, α and β are set values).

21. A scheduling method of a portable Internet system accessed to a voice over Internet protocol (VoIP) system providing a VoIP service through a base station, the scheduling method for transmitting/receiving a packet between a VoIP terminal accessed to the VoIP system and a portable Internet terminal, wherein the packet for connecting a session between the VoIP terminal and the portable Internet terminal is transmitted/received through a management connection of a media access control (MAC) layer and the packet including data for the VoIP service is transmitted/received through an unsolicited grant service (UGS) connection, the scheduling method comprising:
receiving a carrier-to-interference-and-noise ratio (CINR) measurement value from the portable Internet terminal;
calculating a CINR average value among the CINR measurement values;
estimating a CINR variance value based on the CINR measurement value and the CINR average value;
estimating a propagation environment variance direction of the portable Internet terminal based on the CINR average value and the CINR variance value; and
establishing a radio resource allocation method according to the estimated propagation environment variance direction.

22. The scheduling method of claim 21, wherein the estimating of the propagation environment variance direction comprises:
calculating a CINR variance direction value indicating a difference between the CINR measurement value and the CINR average value provided from the portable Internet terminal during a predetermined period;
determining that the propagation environment of the terminal becomes good when the number of positive numbers among the CINR variance direction values is larger than the number of negative numbers; and
determining that the propagation environment of the terminal becomes bad when the number of negative numbers is larger than the number of positive numbers.

23. The scheduling method of claim 21, wherein the transmitting/receiving of the packet comprises:
transmitting a packet that is greater than a first reference value with a period that is greater than a second reference value when the CINR average value is greater than α and the CINR variance value is less than β, or when the CINR average value is greater than α and the CINR variance value is less than β (here, α and β are set values); and
transmitting the packet that is less than the first reference value with a period that is less than the second reference value when the CINR average value is less than α and the CINR variance value is less than β, or when the CINR average value is greater than α and the CINR variance value is greater than β (here, α and β are set values).
